(19) United States
(12) Patent Application Publication
(10) Pub. No.: US 2025/0249804 A1
(43) Pub. Date: Aug. 7, 2025

(54) CHILD RESTRAINT WITH BELT LOCK-OFF

(71) Applicant: Dorel Juvenile Group, Inc., Foxboro, MA (US)

(72) Inventors: William P. MCHUGH, Norfolk, MA (US); Jason H. JOHNSON, Brownstown, IN (US)

(21) Appl. No.: 19/042,379

(22) Filed: Jan. 31, 2025

Related U.S. Application Data
(60) Provisional application No. 63/627,916, filed on Feb. 1, 2024.

(51) Int. Cl. B60N 2/28

(52) U.S. Cl. CPC B60N 2/2806; B60N 2/2816

(57) ABSTRACT

A seat base for a child restraint includes a seat-base foundation adapted to rest on a vehicle seat. The seat-base foundation is formed to include a belt path configured to receive an attachment belt to secure the seat base to the vehicle seat. The seat base further includes a belt lock-off coupled to the seat-base foundation for pivotable movement relative to the seat-base foundation between an opened position and a closed position. In the opened position, the belt lock-off extends away from the belt path to allow placement of the attachment belt in the belt path. In the closed position, the belt lock-off overlies the belt path and clamps the attachment belt to the seat-base foundation within the belt path to block movement of the attachment belt and the seat base relative to the vehicle seat.

### PRIORITY CLAIM

This application claims priority under 35 U.S.C. § 119 (e) to U.S. Provisional Application Ser. No. 63/627,916, filed Feb. 1, 2024, which is expressly incorporated by reference herein.

### BACKGROUND

The present disclosure relates to a seat base for a child restraint, and particularly to a seat base that is configured to mount to a vehicle seat. More particularly, the present disclosure relates to a seat base for a child restraint adapted to receive an attachment belt to secure the seat base to a vehicle seat.

### SUMMARY

According to the present disclosure, a seat base for a child restraint includes a seat-base foundation adapted to rest on a vehicle seat. The seat-base foundation is formed to include a belt path configured to receive an attachment belt to secure the seat base to the vehicle seat.

In illustrative embodiments, the seat base further includes a belt lock-off coupled to the seat-base foundation for pivotable movement relative to the seat-base foundation between an opened position and a closed position. In the opened position, the belt lock-off extends away from the belt path to allow placement of the attachment belt in the belt path. In the closed position, the belt lock-off overlies the belt path and clamps the attachment belt to the seat-base foundation within the belt path to block movement of the attachment belt and the seat base relative to the vehicle seat.

In illustrative embodiments, the seat base further includes a belt-installation indicator configured to indicate to the caregiver when tension of the attachment belt has reached a predetermined amount when the belt-lock off is in the closed position. The belt-installation indicator includes an indicator panel coupled to the belt lock-off for movement therewith between the opened position and the closed position and a panel actuator coupled to the belt lock-off coupled to the belt lock-off for movement therewith between the opened position and the closed position. The indicator panel includes a first indication zone and a second indication zone. The panel actuator is configured to move relative to the belt lock-off between a unloaded configuration and a loaded configuration. In the unloaded configuration, the first indication zone is aligned with an aperture formed in the belt lock-off when the attachment belt has tension less than the predetermined amount. In the loaded configuration, the second indication zone is aligned with the aperture formed in the belt lock-off when the attachment belt has tension at or greater than the predetermined amount.

In illustrative embodiments, the seat base further includes a lock-off movement controller movable between an unloaded configuration and a loaded configuration. In the unloaded configuration, the lock-off movement controller blocks movement of the belt lock-off from the opened position to the closed position when the attachment belt is routed across the belt path and has a tension less than a predetermined amount. In the loaded configuration, the belt lock-off is freed for movement from the opened position to the closed position when the attachment belt is routed across the belt path and has a tension at or greater than the predetermined amount configured to indicate to the caregiver when tension of the attachment belt has reached a predetermined amount.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of a seat base included in a child restraint as shown in FIGS. 3 and 4, the seat base including a seat-base foundation configured to mount to a vehicle seat, a belt lock-off arranged in an opened position to expose a belt path surface of the seat-base foundation, and a belt-installation indicator coupled to the belt-lock off for movement therewith and configured to indicate an installation state of an attachment belt routed across the belt path surface of the seat-base foundation when the belt lock-off is in a closed position to secure the child restraint to the vehicle seat;

FIG. 2 is a view similar to FIG. 1 showing the belt lock-off in the closed position clamping the attachment belt to the seat-base foundation and showing an indicator panel included in the belt-installation indicator displaying an indication to suggest to a user that the attachment belt has a tension at or above a predetermined amount in which the attachment belt blocks substantial movement of the child restraint relative to the vehicle seat;

FIG. 3 is a perspective view of the child restraint showing a juvenile seat mounted on the seat base of FIGS. 1 and 2 in a sideways orientation after the belt lock-off has been moved to the closed position to clamp the vehicle seat belt to the seat-base foundation;

FIG. 4 is a view similar to FIG. 3 showing the child restraint rotated relative to the seat base to a forward-facing orientation to overlie the belt lock-off while the belt lock-off is in the closed position;

FIG. 5 is a perspective and cross sectional view of a portion of the seat-base foundation, the belt lock-off, and the belt-installation indicator showing that the belt-installation indicator includes an indicator panel having a first indication zone and a second indication zone, a panel carrier coupled to the indicator panel, and a load pad configured to engage with the attachment belt in the belt path, and showing the load pad in an unloaded position when tension in the attachment belt is below the predetermined amount to cause the first indication zone to be visible through a window formed in the belt lock-off;

FIG. 6 is a perspective and cross sectional view similar to FIG. 6 showing the load pad in a loaded position when tension in the attachment belt is at or above the predetermined amount to cause movement of the load pad relative to the belt lock-off and, in turn, movement of the panel carrier and the indicator panel relative to the window formed in the belt lock-off so that the second indication zone is displayed through the window;

FIG. 7 is an exploded assembly view of the belt lock-off and the belt-installation indicator;

FIG. 8 is a cross section of a portion of the seat base showing the belt lock-off in the closed position and including a release unit coupled to the belt-lock off and a movable catch coupled to the seat-base foundation to engage with the release unit in a locked position when the belt lock-off is in the closed position;

FIG. 9 is a cross section similar to FIG. 8 showing the release unit in an unlocked position in which an actuator is moved relative to the belt-lock off to cause simultaneous movement of the movable catch relative to the seat-base foundation and away from a latch retainer included in the release unit to free the belt lock-off for movement from the closed position to the opened position;

FIG. 10 is a perspective and cross sectional view of the portion of the seat base shown in FIG. 9 showing the release unit in the unlocked position and the movable catch separated from the latch retainer;

FIG. 11 is a perspective view of the movable catch;

FIG. 12 is perspective view of the seat base showing that the belt-installation indicator is a first belt-installation indicator and showing that the seat base further includes a second belt-installation indication arranged to lie next to the first belt-installation indicator and includes a second indicator panel, a second panel carrier, and a second load pad each movable independently from the first belt-installation indicator;

FIG. 13 is a perspective view of the seat base showing the belt lock-off in the opened position and showing the seat base further including a lock-off movement controller configured to block movement of the belt lock-off to the closed position until the attachment belt applies a load on the belt path at or above a predetermined amount; and

FIG. 14 is a perspective view of the seat base showing the belt lock-off in the closed position after tightening the attachment belt to a tension that applies the load at or above the predetermined amount on the belt path.

### DETAILED DESCRIPTION

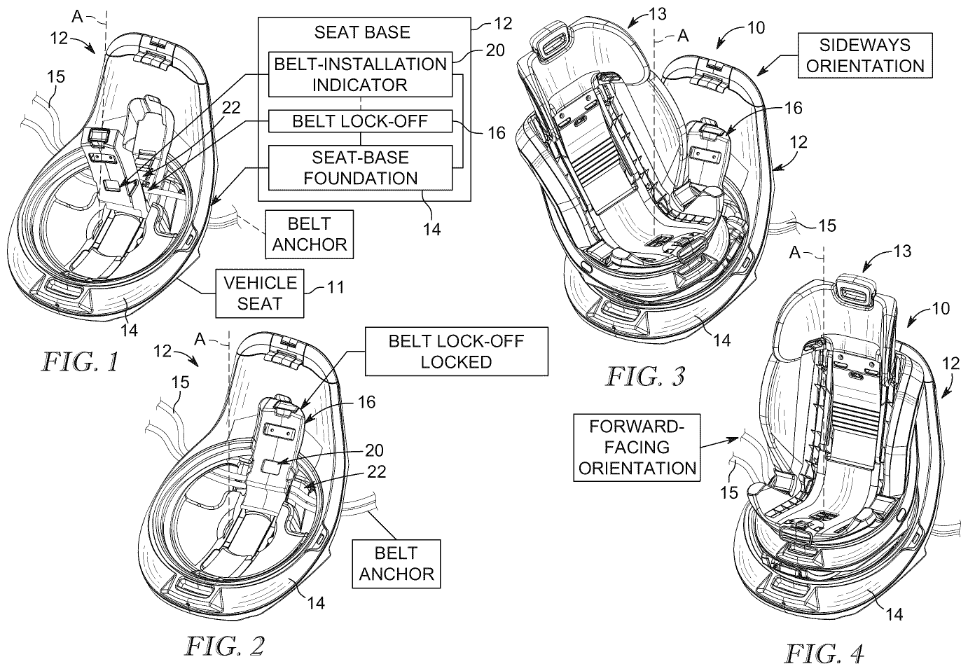

A seat base 12 for a child restraint 10 is adapted to rest on a vehicle seat 11 included in a vehicle to secure a juvenile seat 13 to the vehicle seat 11 as shown in FIGS. 1-4. The seat base 12 includes a seat-base foundation 14 adapted to rest on the vehicle seat 11, a belt lock-off 16, and a belt-installation indicator 20. The seat-base foundation 14 is formed to include a belt path 22 configured to receive an attachment belt 15 to secure the seat base 12 to the vehicle seat 11. The belt lock-off 16 is configured to clamp the attachment belt 15 to the seat-base foundation 14 so that the seat base 12 is secured to the vehicle seat 11. The belt-installation indicator 20 is coupled to the belt lock-off 16 to visually indicate to a caregiver when the tension of the attachment belt 15 has reached a predetermined amount to indicate when the seat base 12 is secured properly to the vehicle seat 11.

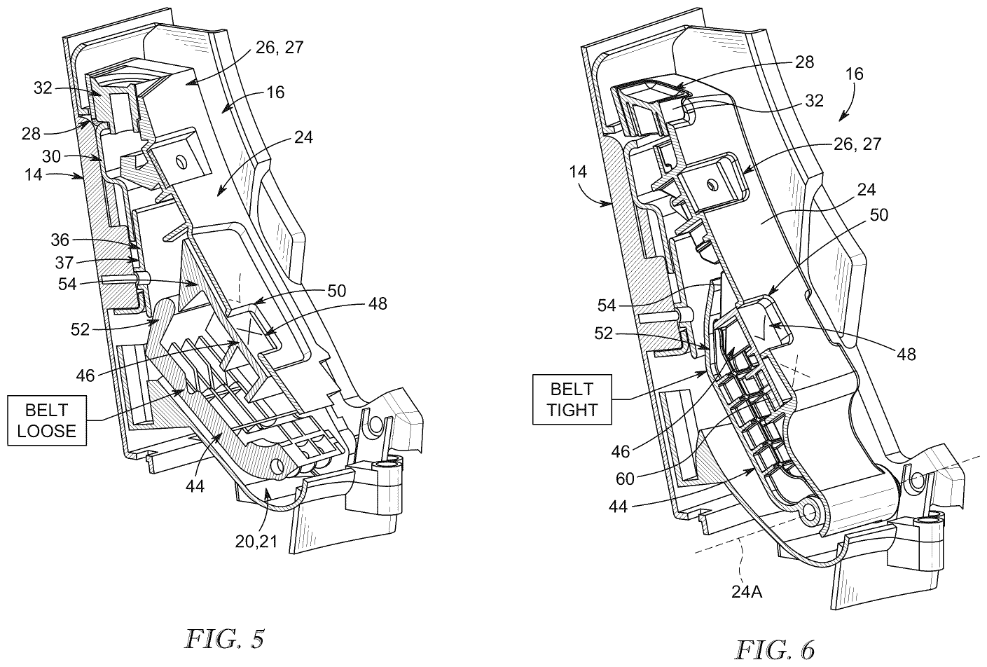

The belt lock-off 16 is configured to clamp the attachment belt 15 to the seat-base foundation 14 within the belt path 22 to block movement of the attachment belt 15 as shown in FIG. 2. The belt lock-off 16 includes a lock-off arm 24 mounted to the seat-base foundation 14, an arm retainer 26 coupled to the lock-off arm 24 for movement therewith, and a lock-off release unit 28 as shown in FIG. 5. The lock-off arm 24 is mounted for pivotable movement about an axis 24A between an opened position and a closed position to selectively clamp the attachment belt 15 between the lock-off arm 24 and the seat-base foundation 14. In the opened position, the lock-off arm 24 is spaced apart from the seat-base foundation 14 to expose the belt path 22 and allow movement of the attachment belt 14 within the belt path 22. In the closed position, the lock-off arm 24 clamps the attachment belt 15 between the lock-off arm 24 and the seat-base foundation 14 to block movement of the attachment belt 15 within the belt path 22. The arm retainer 26 moves with the lock-off arm 24 between the opened position and the closed position, and is configured to block movement of the lock-off arm 24 from the closed position to the opened position. The arm retainer 26 does not move relative to the lock-off arm 24 when the lock-off arm 24 is in both the closed position and the opened position.

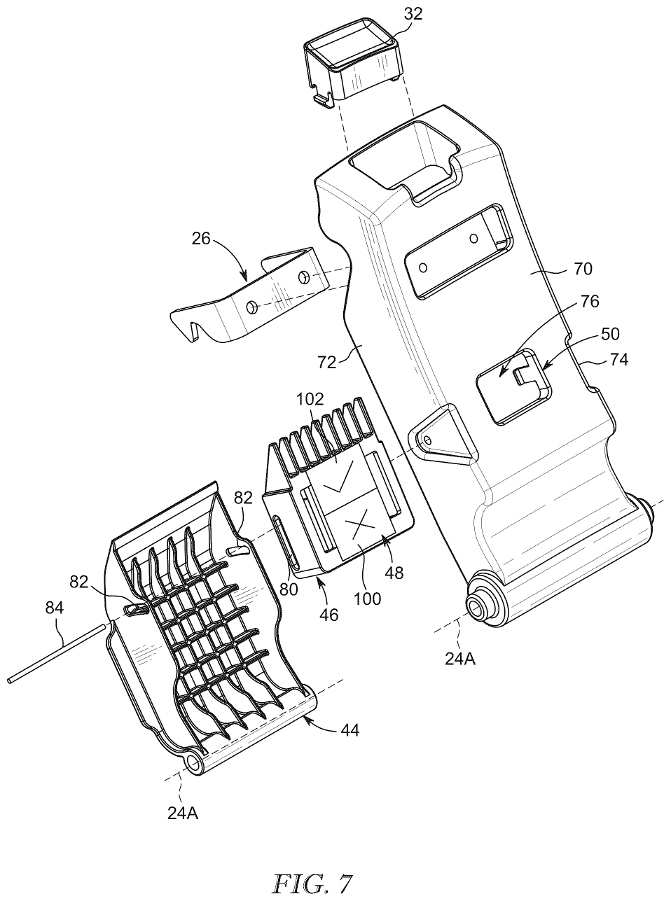

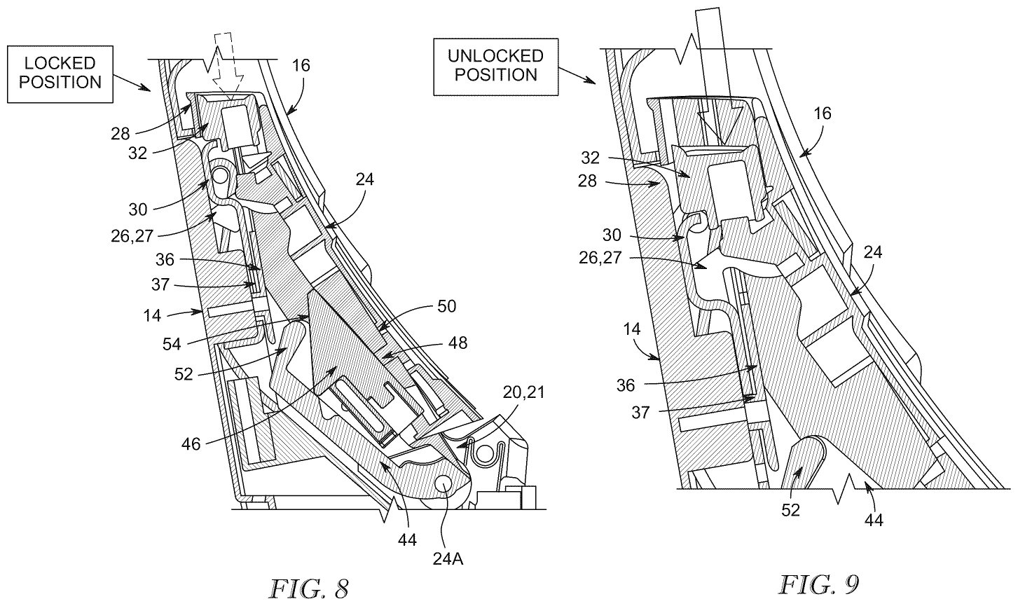

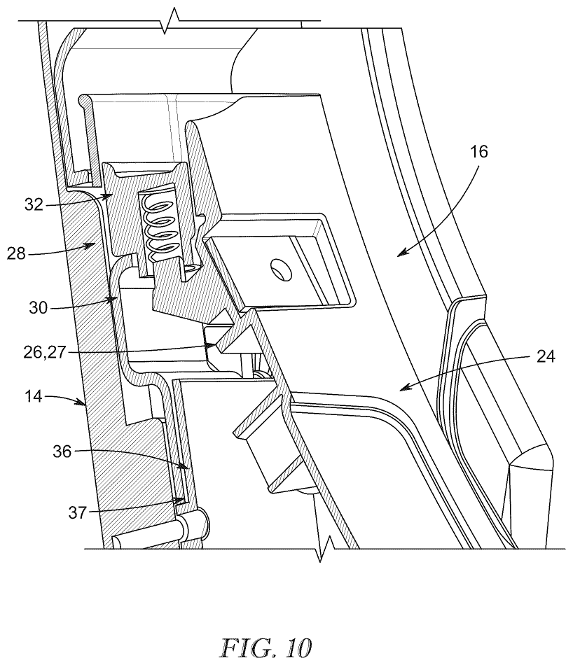

The lock-off release unit 28 includes a movable catch 30 coupled to the seat-base foundation 14 and an actuator button 32 coupled to the lock-off arm 24 as shown in FIGS. 5-10. When the lock-off arm 24 is in the closed position, the actuator button 32 is configured to engage the movable catch 30. The actuator button 32 and the movable catch 30 are movable in unison from a locked position to an unlocked position. In the locked position, the movable catch 30 is positioned relative to the arm retainer 26 to block movement of the lock-off arm 24 from the closed position to the opened position. In the unlocked position, the movable catch 30 is separated from the arm retainer 26 so that the lock-off arm 24 is free to move from the closed position to the opened position. The movable catch 30 and the actuator button 32 may be biased upwardly toward the locked position by one or more springs, for example.

The movable catch 30 is embedded into the seat-base foundation 14 for movement relative to the seat-base foundation 14 and the arm retainer 26. When the lock-off arm 24 is in the closed position the movable catch 30 is spaced a first distance from the arm retainer 26. When the lock-off arm 24 is in the opened position, the movable catch 30 is spaced a second distance from the arm retainer 26 greater than the first distance.

The movable catch 30 and the actuator button 32 are configured to move relative to the arm retainer 26 and the seat-base foundation 14 as the lock-off release unit changes from the locked position to the unlocked position. In the illustrative embodiment, both the movable catch 30 and the actuator button 32 are configured to slide relative to the arm retainer 26 and the seat-base foundation 14 from the locked position to the unlocked position. When the lock-off release unit 28 is in the locked position, the actuator button 32 is spaced a first distance from the arm retainer 26. When the lock-off release unit 26 is in the unlocked position and the lock-off arm 24 is in the closed position, the actuator button 32 is spaced a second distance from the arm retainer 26 that is less than the first distance.

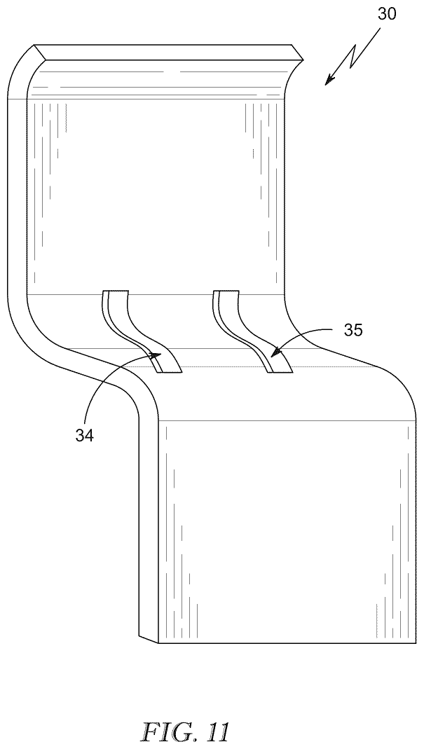

The arm retainer 26 is a first arm retainer 26 formed as a hook and the belt lock-off 16 further includes a second arm retainer 27 formed as a hook and spaced apart laterally from the first arm retainer 26. Additionally, as shown in FIG. 11, the movable catch 30 is formed to include a first slot 34 configured to receive the first arm retainer 26 and a second slot 35 configured to receive the second arm retainer 27 so that the movable catch 30 engages the first arm retainer 26 and the second arm retainer 27 via the slots 34, 35 in the locked position.

The lock-off release unit 28 further includes a catch guide 36 coupled to the seat-base foundation 14 as shown in FIGS. 5-10. The catch guide 36 is configured to at least partially define a guide path 37 between the seat-base foundation 14 and the catch guide 36 to guide sliding movement of the movable catch 30. The guide path 37 guides an end of the movable catch 30 between the seat-base foundation 14 and the catch guide 36 when the movable catch 30 moves relative to the seat-base foundation 14 and the lock-off arm 24. For example, when the lock-off arm 24 moves from the opened position to the closed position, the arm retainer 26 is configured to engage the movable catch 30 to cause the movable catch 30 to slide within the guide path 37 until a portion of the arm retainer 26 is received in the slot(s) 34, 35. The movable catch 30 is then biased to normally assume the locked position once the lock-off arm 24 reaches the closed position. Similarly, when the lock-off arm 24 is in the closed position, moving the actuator button 32 relative to the seat-base foundation 14 and the lock-off arm 24 causes the movable catch 30 to slide within the guide path 37 to remove the arm retainer 26 from the slot(s) 34, 35 so that the lock-off arm 24 is free to pivot to the open position away from the movable catch 30.

The belt-installation indicator 20 visually indicates to the caregiver when the tension of the attachment belt 15 has reached or exceeded a predetermined amount. The belt-installation indicator 20 is coupled to the lock-off arm 24 and moves relative thereto as shown in FIGS. 1 and 2.

The belt-installation indicator 20 includes a load pad 44, a panel carrier 46, and an indicator panel 48 as shown in FIGS. 5 and 6. The load pad 44 is configured to engage the attachment belt 15 when the lock-off arm 24 is in the closed position. The load pad 44 is configured to pivot relative to the lock-off arm 24 when the tension the attachment belt 15 is equal to or above the predetermined amount. The panel carrier 46 is configured to translate relative to the lock-off arm 24 in response to the load pad 44 pivoting relative to the lock-off arm 24. The indicator panel 48 is coupled to the panel carrier 46 and is configured to indicate to the caregiver when the tension of the attachment belt 15 is equal to or above the predetermined amount. In some embodiments, one or both of the load pad 44 and the panel carrier 46 may block pivoting of the lock-off arm 24 to the closed position until tension in the attachment belt 15 has reached a predetermined amount to cause the panel carrier 46 to translate.

The lock-off arm 24 is formed to include a window 50 and the indicator panel 48 is aligned with the window 50 as shown in FIGS. 5 and 6. The indicator panel 48 has a first portion or zone 100 that is visible through the window 50 when the panel carrier 46 is in a first position and a second portion or zone 102 that is visible through the window 50 when the panel carrier 46 is in a second position. The first portion may have a first color or icon to indicate a tension below the predetermined amount and the second portion may have a second color or icon to indicate a tension above the predetermined amount.

The load pad 44 and the panel carrier 46 are included in a panel actuator which further includes a bias member (i.e. a spring) 60 configured to urge the panel carrier 46 toward the first position. In the first position, the panel carrier 46 is biased such that the first portion of the indicator panel 48 is visible through the window 50 when the tension of the attachment belt 15 is below the predetermined amount. The load pad 44 includes a pressing tongue 52 facing toward the panel carrier 46 and the panel carrier 46 includes a ramped surface 54 as shown in FIGS. 3 and 4. The pressing tongue 52 presses against the ramped surface 54 to cause the panel carrier 46 to translate relative to the belt lock-off 16 when the tension of the attachment belt 15 is equal to or above the predetermined amount to move the panel carrier 46 to the second position.

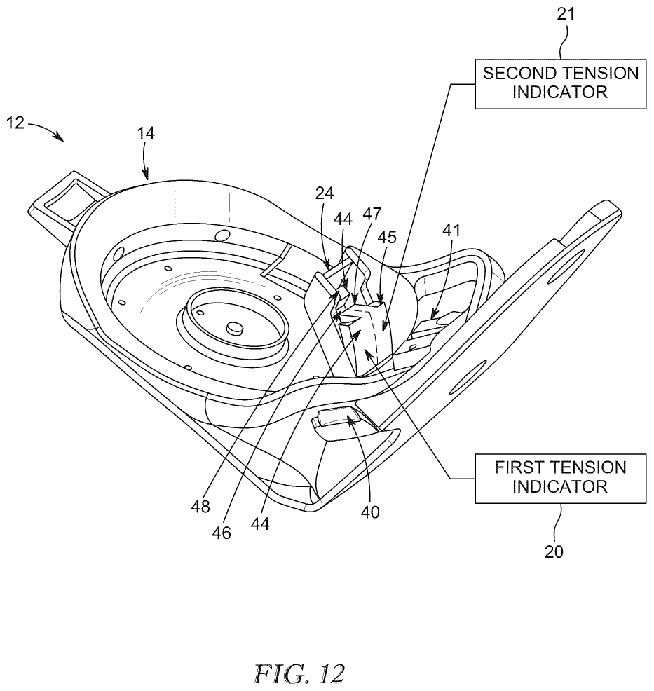

As shown in FIG. 12, the belt-installation indicator 20 may be a first belt-installation indicator 20 and the seat base 12 may further include a second belt-installation indicator 21. The second belt-installation indicator 21 is substantially similar to the first belt-installation indicator 20 described above such that the window 50 displays a indicator panel 48, 49 of both belt-installation indicators 20, 21. The first belt-installation indicator 20 is configured to visually indicate to the caregiver when the tension of the first lateral side of the attachment belt 15 has reached or exceeded the predetermined amount. Similarly, the second belt-installation indicator 21 is configured to visually indicate to the caregiver when the tension applied to the belt tensioning device 18 by the second lateral side of the attachment belt 15 has reached or exceeded the predetermined amount. The two belt-installation indicators 20, 21 move independently of one another to ensure that the seat base 12 is secured to the vehicle seat 11 evenly by the attachment belt 15 on the first lateral side and the second lateral side.

As described above, the first belt-installation indicator 20 includes the first load pad 44, the first panel carrier 46 and the first indicator panel 48 to indicate that the tension of the attachment belt 15 on the first lateral side has reached the predetermined amount. Similarly, the second belt-installation indicator includes a second load pad 45, a second panel carrier 47, and a second indication zone 49 to indicate that the tension of the attachment belt 15 on the second lateral side has reached the predetermined amount. The second load pad 45 is configured to engage the attachment belt 15 on the second lateral side when the lock-off arm 24 is in the closed position. The second load pad 45 is also configured to pivot relative to the lock-off arm 24 when the tension the attachment belt 15 on the second lateral side is equal to or above the predetermined amount. The second panel carrier 47 is configured to translate relative to the lock-off arm 24 in response to the second load pad 45 pivoting relative to the lock-off arm 24. The second indication zone 49 is coupled to the second panel carrier 47 and is configured to indicate to the caregiver when the tension of the attachment belt 15 on the second lateral side is equal to or above the predetermined amount. In some embodiments, one or both of the second load pad 45 and the second panel carrier 47 may block pivoting of the lock-off arm 24 to the closed position until tension in the attachment belt 15 has reached a predetermined amount to cause the panel carrier 46 to translate.

When the first panel carrier 46 and the second panel carrier 47 are in the first position, the first and second carriers 46, 47 are biased such that the first portion of each indicator panel 48, 49 is visible through the window 50 when the tension of the first lateral side and the second lateral side of the attachment belt 15 is below the predetermined amount. If the tension of the first lateral side of the attachment belt 15 is at or above the predetermined amount and the tension of the second lateral side of the attachment belt 15 is below the predetermined amount, then the first panel carrier 46 is in the second position and the second panel carrier 47 is in the first portion. The first panel carrier 46 is in the second position to show the second portion of the first label 48 through the window 50 to indicate to the caregiver that the tension of the first lateral side of the attachment belt is at or above the predetermined amount. The second panel carrier 47 is in the first position to show the first portion of the second label 49 through the window 50 to indicate to the caregiver that the tension of the second lateral side of the attachment belt 15 is below the predetermined amount and needs to be adjusted.

Like the first load pad 44 and the first panel carrier 46, the second load pad 45 includes a second pressing tongue facing toward the second panel carrier 47 and the second panel carrier 47 includes a second ramped surface. The first and second tongue 52 press against the respective first and second ramped surfaces 54 to cause the first and second carriers 46, 47 to translate relative to the belt lock-off 16 when the tension of the first and second lateral sides of the attachment belt 15 is equal to or above the predetermined amount to move the first and second carriers 46, 47 to the second position.

The belt lock-off arm 24 includes a top wall 70 formed to include the aperture 50, a first side wall 72 coupled to a first lateral end of the top wall 70, and a second side wall 74 coupled to a second lateral end of the top wall 70, opposite the first lateral end. The first and second side walls 72, 74 extend away from the top wall 70 toward the belt path 22 in the closed position, to provide a panel-receiving space 76 between the first side wall 72 and the second side wall 74. The panel-receiving space 76 is configured to at least partially receive the indicator panel 48, the panel carrier 46, and the load pad 44.

The panel carrier 46 is formed to include a linear guide slot 80 and the load pad 44 is formed to include a curved guide slot 82 arranged to extend about the axis 24A about which the load pad 44 pivots during movement from the unloaded position to the loaded position. A pin 84 extends through the linear guide slot 80 and the curved guide slot 82 and attaches to the first side wall 72 and the second side wall 74 to guide movement of the load pad 44 and the panel carrier 46 relative to the belt lock-off 16. In some embodiments, the load pad 44 may pivot about an axis that is offset from the pivot axis 24A.

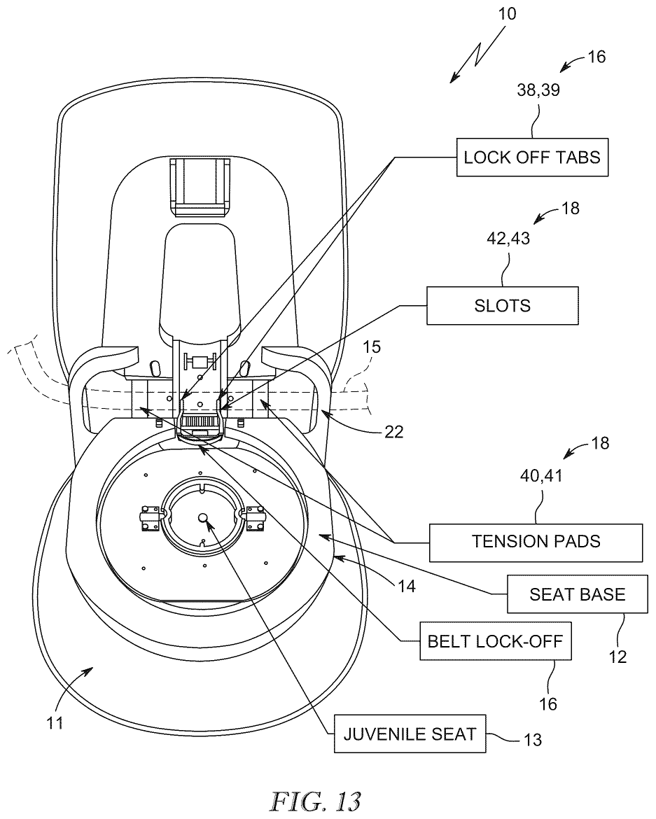

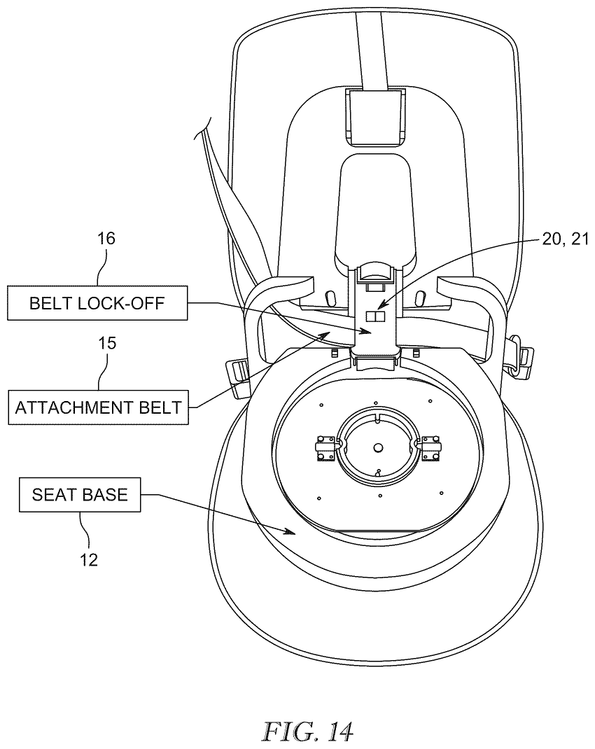

In illustrative embodiments, the belt lock-off 16 may include a lock-off movement controller including a first lock-off tab 38, a second lock-off tab 39, a first tension pad 40 formed to include a first slot 42 and a second tension pad 41 formed to include a second slot 43 as shown in FIGS. 13 and 14. The first tension pad 40 is located on a first lateral side of the belt path, the second tension pad 41 is located on a second lateral side of the belt path, and the belt lock-off 16 is positioned between the first and second tension pads 40, 41.

To change the belt lock-off 16 from the opened position to the closed position, the vehicle seat belt 18 is positioned over the tension pads 40, 41 and applies a force thereto to move the tension pads 40, 41 inward toward the underlying vehicle seat when the force is greater than or equal to the predetermined force. The slots 42, 43 moves with each respective tension pad 40, 41 to align with each respective lock-off tab 38, 39 after proper force is applied so that the belt lock-off 16 may pivot to the closed position and clamp the vehicle belt 18 to the seat base 12. The belt lock-off 16 is blocked from movement to the closed position when the tension pads 40, 41 are in a travel path of the tabs 38, 39, i.e. when the slots 42, 43 and the lock-off tabs 38, 39 are not aligned. The vehicle belt 18 is blocked from sliding relative to the seat base 12 when the belt lock-off 16 is in the closed position.

The seat base 12 may include additional features described in U.S. Patent Publication No. 2023/0045293, filed on Aug. 5, 2022, the disclosure of which expressly incorporated by reference herein in their entirety for the purpose of describing a belt retainer and status indications of the belt retainer. The juvenile seat 13 may be rotatable relative to the seat base 12 about an axis A. The attachment belt 15 may be a part of the vehicle seat or a separate belt used to attach the child restraint to the vehicle seat.

1. A seat base for a child restraint configured to hold and restrain a child for transportation in a vehicle, the seat base comprising:
a seat-base foundation adapted to rest on a vehicle seat included in the vehicle, the seat-base foundation formed to include a belt path configured to receive an attachment belt to secure the seat base to the vehicle seat,
a belt lock-off coupled to the seat-base foundation for pivotable movement relative to the seat-base foundation between an opened position extending away from the belt path to allow placement of the attachment belt in the belt path, and a closed position overlying the belt path and clamping the attachment belt to the seat-base foundation within the belt path to block movement of the attachment belt, and
a belt-installation indicator configured to indicate to the caregiver when tension of the attachment belt has reached a predetermined amount when the belt-lock off is in the closed position,
wherein the belt-installation indicator includes: (i) an indicator panel coupled to the belt lock-off for movement therewith between the opened position and the closed position and having a first indication zone and a second indication zone and (ii) a panel actuator coupled to the belt lock-off for movement with the belt lock-off between the opened position and the closed position and for movement relative to the belt lock-off between a unloaded configuration, in which the first indication zone is aligned with an aperture formed in the belt lock-off when the attachment belt has tension less than the predetermined amount, and a loaded configuration, in which the second indication zone is aligned with the aperture formed in the belt lock-off when the attachment belt has tension at or greater than the predetermined amount.

2. The seat base of claim 1, wherein the panel actuator includes (i) a panel carrier coupled to the belt lock-off for movement therewith between the opened position and the closed position and to the indicator panel for movement with the indicator panel between a first indication position in which the first indication zone is aligned with an aperture formed in the belt lock-off and a second indication position in which the second indication zone is aligned with the aperture, and (ii) a load pad coupled to the belt lock-off for movement therewith between the opened position and the closed position and for pivotable movement relative to the belt lock-off between an unloaded position when the tension in the attachment belt is below the predetermined amount and a loaded position when the tension in the attachment belt is at or above the predetermined amount to cause the panel actuator to move from the first indication position to the second indication position so that the second indication zone is displayed through the aperture.

3. The seat base of claim 2, wherein the belt lock-off is pivotable relative to the seat-base foundation about a lock-off axis between the opened position and the closed position and the load pad is pivotable about the lock-off axis: (i) with the belt lock-off between the closed position and the opened position and (ii) relative to the belt lock-off between the unloaded position and the loaded position.

4. The seat base of claim 2, wherein the belt lock-off includes a top wall formed to include the aperture, a first side wall coupled to a first lateral end of the top wall and extending away from the top wall toward the belt path in the closed position, and a second side wall coupled to a second lateral end of the top wall, opposite the first lateral end, and extending away from the top wall toward the belt path in the closed position to provide a panel-receiving space between the first side wall and the second side wall and configured to at least partially receive the indicator panel, the panel carrier, and the load pad.

5. The seat base of claim 4, wherein the indicator panel is mounted to the first side wall and the second side wall for translation relative to the belt lock-off between the first indication position and the second indication position.

6. The seat base of claim 5, wherein the panel carrier is formed to include a linear guide slot and the load pad is formed to include a curved guide slot arranged to extend about an axis about which the load pad pivots during movement from the unloaded position to the loaded position, and a pin extends through the linear guide slot and the curved guide slot and attaches to the first side wall and the second side wall to guide movement of the load pad and the panel carrier relative to the belt lock-off.

7. The seat base of claim 6, wherein the panel carrier includes a carrier body formed with the linear guide slot and a ramped surface arranged to engage the load pad, and wherein the load pad is configured to press against the ramped surface to cause the panel carrier to translate relative to the belt lock-off when the tension of the attachment belt is at or above the predetermined amount to move the panel carrier to the second indication position.

8. The seat base of claim 1, wherein the belt-installation indicator is a first belt-installation indicator and the seat base further comprises a second belt-installation indicator coupled to the belt lock-off for movement therewith between the closed position and the opened position, the second belt-installation indicator including: (i) a second indicator panel coupled to the belt lock-off for movement therewith between the opened position and the closed position and having a first indication zone and a second indication zone separate and movable independently from the first indication zone and the second indication zone of the first belt-installation indicator and (ii) a second panel actuator coupled to the belt lock-off for movement with the belt lock-off between the opened position and the closed position and for movement relative to the belt lock-off and the first belt-installation indicator between a unloaded configuration, in which the first indication zone of the second indicator panel is displayed for when the attachment belt has tension less than the predetermined amount, and a loaded configuration, in which the second indication zone is displayed when the attachment belt has tension at or greater than the predetermined amount.

9. The seat base of claim 8, wherein each panel actuator includes (i) a panel carrier coupled to the belt lock-off for movement therewith between the opened position and the closed position and to each respective indicator panel for movement with each respective indicator panel between a first indication position displaying the first indication zone and a second indication position displaying the second indication zone, and (ii) a load pad coupled to the belt lock-off for movement therewith between the opened position and the closed position and for pivotable movement relative to the belt lock-off between an unloaded position when the tension in the attachment belt is below the predetermined amount and a loaded position when the tension in the attachment belt is at or above the predetermined amount to cause each respective panel actuator to move from the first indication position to the second indication position.

10. A seat base for a child restraint configured to hold and restrain a child for transportation in a vehicle, the seat base comprising:
a seat-base foundation adapted to rest on a vehicle seat included in the vehicle, the seat-base foundation formed to include a belt path configured to receive an attachment belt to secure the seat base to the vehicle seat,
a belt lock-off coupled to the seat-base foundation for pivotable movement relative to the seat-base foundation between an opened position extending away from the belt path to allow placement of the attachment belt in the belt path, and a closed position overlying the belt path and clamping the attachment belt to the seat-base foundation within the belt path to block movement of the attachment belt, and
a lock-off movement controller movable between an unloaded configuration blocking movement of the belt lock-off from the opened position to the closed position when the attachment belt is routed across the belt path and has a tension less than a predetermined amount, and a loaded configuration freeing the belt lock-off for movement from the opened position to the closed position when the attachment belt is routed across the belt path and has a tension at or greater than the predetermined amount configured to indicate to the caregiver when tension of the attachment belt has reached a predetermined amount.

11. The seat base of claim 10, wherein the lock-off movement controller includes a first load pad coupled to the seat base foundation on a first lateral side of the belt lock-off and a second load pad coupled to the seat base foundation on an opposite, second lateral side of the belt lock-off, the first and second load pads each being movable relative to the seat-base foundation and the belt lock-off from: (i) a first position in line with a travel path of at least a portion of the belt lock-off to establish the unloaded configuration and block the belt lock-off from moving from the opened position to the closed position and (ii) a second position removed from the travel path of the belt lock-off to establish the loaded configuration and free the belt lock-off for movement to the closed position.

12. The seat base of claim 11, further comprising a belt-installation indicator including an indicator panel coupled to the belt lock-off for movement therewith between the opened position and the closed position and configured to indicate when the belt lock-off is in the closed position.

13. A seat base for a child restraint configured to hold and restrain a child for transportation in a vehicle, the seat base comprising:
a seat-base foundation adapted to rest on a vehicle seat included in the vehicle, the seat-base foundation formed to include a belt path configured to receive an attachment belt to secure the seat base to the vehicle seat,
a belt lock-off coupled to the seat-base foundation for pivotable movement relative to the seat-base foundation between an opened position extending away from the belt path to allow placement of the attachment belt in the belt path, and a closed position overlying the belt path and clamping the attachment belt to the seat-base foundation within the belt path to block movement of the attachment belt,
a lock-off movement controller movable between an unloaded configuration blocking movement of the belt lock-off from the opened position to the closed position when the attachment belt is routed across the belt path and has a tension less than a predetermined amount, and a loaded configuration freeing the belt lock-off for movement from the opened position to the closed position when the attachment belt is routed across the belt path and has a tension at or greater than the predetermined amount configured to indicate to the caregiver when tension of the attachment belt has reached a predetermined amount, and
a belt-installation indicator configured to indicate to the caregiver when tension of the attachment belt has reached the predetermined amount.

14. The seat base of claim 13, wherein the belt-installation indicator includes: (i) an indicator panel coupled to the belt lock-off for movement therewith between the opened position and the closed position and having a first indication zone and a second indication zone and (ii) a panel actuator coupled to the belt lock-off for movement with the belt lock-off between the opened position and the closed position and for movement relative to the belt lock-off between a unloaded configuration, in which the first indication zone is aligned with an aperture formed in the belt lock-off when the attachment belt has tension less than the predetermined amount, and a loaded configuration, in which the second indication zone is aligned with the aperture formed in the belt lock-off when the attachment belt has tension at or greater than the predetermined amount.

15. The seat base of claim 14, wherein the panel actuator includes (i) a panel carrier coupled to the belt lock-off for movement therewith between the opened position and the closed position and to the indicator panel for movement with the indicator panel between a first indication position in which the first indication zone is aligned with an aperture formed in the belt lock-off and a second indication position in which the second indication zone is aligned with the aperture, and (ii) a load pad coupled to the belt lock-off for movement therewith between the opened position and the closed position and for pivotable movement relative to the belt lock-off between an unloaded position when the tension in the attachment belt is below the predetermined amount and a loaded position when the tension in the attachment belt is at or above the predetermined amount to cause the panel actuator to move from the first indication position to the second indication position so that the second indication zone is displayed through the aperture.

16. The seat base of claim 15, wherein the belt lock-off is pivotable relative to the seat-base foundation about a lock-off axis between the opened position and the closed position and the load pad is pivotable about the lock-off axis: (i) with the belt lock-off between the closed position and the opened position and (ii) relative to the belt lock-off between the unloaded position and the loaded position.

17. The seat base of claim 15, wherein the belt lock-off includes a top wall formed to include the aperture, a first side wall coupled to a first lateral end of the top wall and extending away from the top wall toward the belt path in the closed position, and a second side wall coupled to a second lateral end of the top wall, opposite the first lateral end, and extending away from the top wall toward the belt path in the closed position to provide a panel-receiving space between the first side wall and the second side wall and configured to at least partially receive the indicator panel, the panel carrier, and the load pad.

18. The seat base of claim 17, wherein the indicator panel is mounted to the first side wall and the second side wall for translation relative to the belt lock-off between the first indication position and the second indication position.

19. The seat base of claim 13, wherein the belt-installation indicator is a first belt-installation indicator and the seat base further comprises a second belt-installation indicator coupled to the belt lock-off for movement therewith between the closed position and the opened position, the second belt-installation indicator including: (i) a second indicator panel coupled to the belt lock-off for movement therewith between the opened position and the closed position and having a first indication zone and a second indication zone separate and movable independently from the first indication zone and the second indication zone of the first belt-installation indicator and (ii) a second panel actuator coupled to the belt lock-off for movement with the belt lock-off between the opened position and the closed position and for movement relative to the belt lock-off and the first belt-installation indicator between a unloaded configuration, in which the first indication zone of the second indicator panel is displayed for when the attachment belt has tension less than the predetermined amount, and a loaded configuration, in which the second indication zone is displayed when the attachment belt has tension at or greater than the predetermined amount.

20. The seat base of claim 19, wherein each panel actuator includes (i) a panel carrier coupled to the belt lock-off for movement therewith between the opened position and the closed position and to each respective indicator panel for movement with each respective indicator panel between a first indication position displaying the first indication zone and a second indication position displaying the second indication zone, and (ii) a load pad coupled to the belt lock-off for movement therewith between the opened position and the closed position and for pivotable movement relative to the belt lock-off between an unloaded position when the tension in the attachment belt is below the predetermined amount and a loaded position when the tension in the attachment belt is at or above the predetermined amount to cause each respective panel actuator to move from the first indication position to the second indication position.
